(19) United States
(12) Patent Application Publication
(10) Pub. No.: US 2015/0342409 A1
(43) Pub. Date: Dec. 3, 2015

(54) DOMESTIC APPLIANCE

(71) Applicant: Dyson Technology Limited, Wiltshire (GB)

(72) Inventors: Henry Licming LAMBOURN, Swindon (GB); Stephen Benjamin COURTNEY, Bath (GB); Jonathan Stephen MARCHBANK, Chester (GB)

(73) Assignee: Dyson Technology Limited, Wiltshire (GB)

(21) Appl. No.: 14/727,486

(22) Filed: Jun. 1, 2015

(30) Foreign Application Priority Data
Jun. 2, 2014 (GB) 1409771.1
Jun. 2, 2014 (GB) 1409773.7

(51) Int. Cl. A47J 43/046; B01F 7/16; B01F 7/00

(52) U.S. Cl. CPC A47J 43/046; B01F 7/0025; B01F 7/162; B01F 2215/0014

(57) ABSTRACT

A domestic blender has a receptacle and a tool. The receptacle has a bottom wall, a side wall defining an opening through which foodstuff material is introduced to the receptacle, and a longitudinal axis about which the side wall is disposed. The tool has a processing member located within the receptacle adjacent to the bottom wall, extending outwardly from a rotational axis of the tool passing through the bottom wall and being inclined relative to the longitudinal axis of the receptacle. The processing member is rotatable about the rotational axis to describe a swept volume having a cross-section defined by the intersection of the swept volume with a plane extending through and containing both the longitudinal axis and the rotational axis, the cross-section having a first section having a lateral surface substantially orthogonal to the longitudinal axis, and a second section having a lateral surface substantially parallel to that axis.

### REFERENCE TO RELATED APPLICATIONS

This application claims the priority of United Kingdom Application Nos. 1409771.1 and 1409773.7, filed Jun. 2, 2014, the entire contents of which are incorporated herein by reference.

### FIELD OF THE INVENTION

The present invention relates to a domestic appliance, and in a preferred embodiment relates to a domestic blender or mixer for processing foodstuff material.

### BACKGROUND OF THE INVENTION

A blender generally comprises a receptacle in the form of a jug for receiving foodstuff material, and a tool located within the jug for engaging the received foodstuff material. The tool typically comprises a pair of diametrically opposed blades located adjacent to the bottom wall of the jug. The jug is mounted on a base which contains a motor which is connected to the tool when the jug is mounted on the base.

### SUMMARY OF THE INVENTION

In a first aspect, the present invention provides a blender comprising a receptacle and a tool located within the receptacle. The receptacle has a bottom wall, a side wall defining an opening through which foodstuff material is introduced to the receptacle, and a longitudinal axis about which the side wall is disposed. The bottom wall preferably comprises a wall surface having a non-planar, preferably curved, segment with a shape which comprises a vertex, with the vertex being spaced from the longitudinal axis of the receptacle. The tool comprises a processing member for engaging foodstuff material, the processing member extending outwardly relative to a rotational axis of the tool, and being rotatable about the rotational axis to describe a swept volume. The rotational axis preferably passes through the vertex and is inclined relative to the longitudinal axis of the receptacle.

The swept volume preferably has an outer lateral surface facing the segment of the wall surface, and which increases in width from a proximal portion adjacent to the rotational axis to a distal portion remote from the rotational axis. At least the distal portion of this lateral surface preferably has a shape which is substantially the same as that of an adjacent facing portion of the segment of the wall surface.

The segment of the wall surface preferably has a non-planar, axially symmetrical shape, with an axis of symmetry passing through the vertex of the axially symmetrical shape. As mentioned above, this segment of the wall surface is preferably curved, and preferably has a substantially circular cross-section in a plane which is orthogonal to the axis of symmetry of the shape of the segment of the wall surface. As the swept volume has a circular cross-section in such a plane, providing the segment of the wall surface with a curved shape can allow the wall surface to have a shape which conforms closely to the shape of at least the distal portion of the lateral surface of the swept volume. However, this cross-section may be non-circular, and may for example have a polygonal or lobed shape. This shape may have an n-fold rotational symmetry, where n is preferably greater than 6, more preferably greater than 8, so that while there may be a geometrical difference between the shape of the lateral surface of the swept volume and the shape of the segment of the wall surface, the wall surface still has a shape which conforms closely to, and so is substantially similar to, the shape of at least the distal portion of the lateral surface of the swept volume.

The rotational axis of the tool is preferably collinear with the axis of symmetry of the shape of the curved segment of the wall surface, and so, as appropriate, references below to “the axis of symmetry” or “the axis of symmetry of the shape of the segment of the wall surface” may be replaced with references to “the rotational axis of the tool”, and vice versa.

For example, the segment of the wall surface may have one of a conical shape, a frustoconical shape, a concave shape, a convex shape and a faceted shape, such as a truncated pyramid. The concave shape may be bowl-shaped, or have a curvature which is substantially spherical. The convex shape may be dome-shaped, or have a curvature which is substantially spherical. As used herein, the term “vertex” refers to the point or origin from which the shape of the segment of the wall surface extends. As the rotational axis of the tool passes through the vertex, the vertex will not itself lie on the wall surface, but will be a virtual point lying on the shape described by the wall surface. For example, for a conical, frustoconical, pyramid or faceted shape, the vertex corresponds to the apex of the shape, whereas for a concave or convex wall surface the vertex corresponds to the point of highest curvature of the shape. For a shape with spherical curvature, or any other axially symmetric shape, the vertex refers to the point of the shape through which the axis of symmetry of the shape passes.

When viewed in a plane which extends through and contains the axis of symmetry of the shape of the segment of the wall surface, the segment of the wall surface has two sections; a first section lying to one side of the rotational axis and a second section lying to the other side of the rotational axis. Due to the symmetry of the shape of the segment of the wall surface, the second section is a mirror image of the first section. The processing member has a surface which faces the segment of the wall surface, and which defines the outer lateral surface of the volume swept by the tool as it rotates about the rotational axis. When viewed in the aforementioned plane, the swept volume comprises a first section located adjacent to the first section of the segment of the wall surface, and a second section located adjacent to the second section of the segment of the wall surface.

The lateral surface of the swept volume faces the segment of the wall surface. With the processing member shaped so as to extend outwardly from the rotational axis of the tool, this lateral surface has a width that varies between a proximal portion located proximate, or adjacent to, the rotational axis of the tool and a distal portion located remote from the rotational axis of the tool. As mentioned above, at least this distal portion of the lateral surface of the swept volume preferably has a shape which is substantially the same as that of an adjacent facing portion of the segment of the wall surface. In other words, at least the distal portion of the lateral surface of each section of the swept volume is substantially parallel to, but spaced from, an adjacent facing portion of its respective section of the segment of the wall surface.

Whilst only the distal portion of the lateral surface may have a shape which matches that of the adjacent facing portion of the segment of the wall surface, it is preferred that a majority of the lateral surface has such a shape. In a preferred embodiment, at least 50 percent of the surface area of the lateral surface, more preferably at least 75 percent of the surface area of the lateral surface, and more preferably still substantially the entire lateral surface of the swept volume has a shape which is substantially the same as that of the segment of the wall surface.

The wall surface is preferably integral with the bottom wall of the receptacle, and so is preferably provided by an inner wall surface of the bottom wall. Alternatively, the wall surface may be provided by a separate component, such as a wall lining, which is connected to or lying against the bottom wall of the receptacle and so may be considered to form part of the bottom wall.

The side wall of the receptacle is preferably centred on the longitudinal axis of the receptacle. The longitudinal axis is preferably a straight line, and is preferably vertical when the blender is located on a horizontal work surface. The receptacle preferably has a height which extends in a first direction which is parallel to the longitudinal axis of the receptacle. The receptacle preferably has a width which extends in a second direction which is substantially orthogonal to the longitudinal axis of the receptacle. The receptacle preferably has a depth which is substantially orthogonal to both the length and the width.

The swept volume preferably extends in this second direction substantially the full width of the receptacle. To avoid clashing between the tool and the segment of the wall surface during rotation of the tool, the size of the outer lateral surface of the swept volume is slightly smaller than that of the segment of the wall surface so that the outer lateral surface of the swept volume is surrounded by the segment of the wall surface. At any point along the segment of the wall surface, the distance between the segment of the wall surface and the outer lateral surface of the swept volume is preferably no greater than 10 mm, more preferably between 1 and 10 mm.

The combination of the inclination of the rotational axis of the tool relative to the longitudinal axis of the receptacle with the close conformity of the shape of the segment of the wall surface to at least the distal portion of the lateral surface of the swept volume can inhibit the settling of unprocessed or partially processed foodstuff material within the receptacle during a blending operation, enhancing the consistency of the movement of the foodstuff material and the ease of operation of the blender.

An angle subtended between the longitudinal axis of the receptacle and the rotational axis of the tool is preferably in the range from 15 to 75°, more preferably in the range from 30 to 60°, and even more preferably in the range from 40 to 50°. In a preferred embodiment the angle subtended between the longitudinal axis of the receptacle and the rotational axis of the tool is 45°.

In one preferred embodiment, the segment of the wall surface has a frustoconical shape. The shape of the segment of the wall surface is such that the cone angle of the shape is approximately 90°, and the axis of symmetry of the shape of the segment of the wall surface is inclined at an angle of 45° to the longitudinal axis of the receptacle. Consequently, when viewed in a plane which extends through and contains both the longitudinal axis of the receptacle and the rotational axis of the tool, the segment of the wall surface has a first section which is orthogonal to the longitudinal axis of the receptacle, and a second section which is parallel to the longitudinal axis of the receptacle. With the longitudinal axis of the receptacle in a vertical orientation, the segment of the wall surface may be considered to sweep upwardly about the rotational axis (or the axis of symmetry of the shape of the segment of the wall surface) from a horizontal first section to a vertical second section, and to sweep downwardly about the rotational axis from the second section back to the first section. This particular orientation is preferred as it prevents less readily processed foodstuff material from settling on any angled surfaces within the receptacle.

The side wall preferably has a lower end which is connected to the bottom wall, and an upper end located opposite to the lower end. To facilitate the loading of the receptacle with foodstuff material, the upper end of the side wall preferably defines the opening. The opening is preferably arranged in a plane which is orthogonal to the longitudinal axis of the receptacle. The longitudinal axis of the receptacle preferably passes through the opening, and more preferably through the centre of the opening. Alternatively, the opening may be spaced from the longitudinal axis of the receptacle.

The side wall may comprise a single side wall which extends from the bottom wall to the upper end of the receptacle. This side wall may thus comprise a tubular side wall which has a lower end connected to the bottom wall. In the preferred embodiment, this curved side wall has a cross-section which has an elliptical cross-section in a plane which is orthogonal to the longitudinal axis of the receptacle. Such a side wall is referred to hereafter as an elliptical side wall. Where the receptacle comprises a single elliptical side wall, the opening may also be elliptical in shape.

Alternatively, the side wall may comprise a plurality of side wall sections which together extend around, or are disposed about, the longitudinal axis of the receptacle. These side wall sections may comprise planar side wall sections, curved side wall sections, or both planar and curved side wall sections.

For example, the side wall may comprise a first curved side wall section connected to the bottom wall, and a second side wall section connected to the first curved side wall section. The first curved side wall section may be an elliptical side wall section. The second side wall section may be connected to the upper end of the first side wall section so as to vary the cross-sectional shape of the side wall towards the upper end of the receptacle. Alternatively, a part of the curved side wall may be cutaway, for example through making an oblique slice through the curved side wall, and replaced by a second planar or non-planar side wall section. This second side wall section may be provided adjacent to a handle of the receptacle to facilitate gripping of the handle by a user. In such a case, the cross-section of the side wall may vary between the bottom wall and the opening, but would maintain the general shape of a convex closed curve or closed shape having a non-unitary aspect ratio, which is the ratio of the maximum length to the maximum width of the cross-section.

As another example, the side wall may comprise a plurality of planar side wall sections which together extend around the longitudinal axis of the receptacle, and which define a side wall having a cross-section with the general shape of a convex polygon. Again, the shape of the cross-section may vary along the longitudinal axis of the receptacle. The planar side wall sections may be joined by rounded corners. The number of such planar side wall sections may be the same as, or different from, the number of facets of the segment of the wall surface of the bottom wall of the receptacle. The convex polygon preferably also has a non-unitary aspect ratio.

As a further example, the side wall may comprise a plurality of curved side wall sections which together extend around the longitudinal axis of the receptacle. The sections may define a side wall having a cross-section with a lobed shape or petal-shape. The cross-section may contain any number of sections, and the sections may be arranged regularly or irregularly about the longitudinal axis of the receptacle. The sections may have the same shape, or at least some of the sections may have different shapes. For example, one of the sections may have a circular curvature, whereas another one of the sections may have a non-circular curvature, such as an elliptical curvature. As another example, two of the sections may have dissimilar, non-circular curvatures.

The lower end of the side wall is preferably located within a plane which is inclined relative to the longitudinal axis of the receptacle. In other words, the shape of the lower end of the side wall has a different aspect ratio to the cross-sectional shape of the side wall. An angle subtended between the longitudinal axis of the receptacle and this plane may be substantially the same as an angle subtended between the longitudinal axis of the receptacle and the rotational axis of the tool. As mentioned above, an angle subtended between the longitudinal axis of the receptacle and the rotational axis of the tool is preferably 45°. Where the receptacle has an elliptical side wall, or an elliptical side wall section, connected to the bottom wall, the lower end of the side wall preferably lies in a plane which is at an angle of 45° to the longitudinal axis, and is preferably arranged so that the lower end of the side wall is substantially in the shape of a circle.

The segment of the wall surface of the bottom wall preferably adjoins the lower end of the side wall. In other words, the segment of the wall surface preferably has a substantially circular open end which is contiguous with the lower end of the side wall. However, depending on the shape of any styling between the segment of the wall surface and the lower end of the side wall the open end of the segment of the wall surface need not be geometrically circular. Alternatively, another segment of the wall surface may extend between the segment of the wall surface and the lower end of the side wall, with the result that at least one of the open end of the segment of the wall surface and the lower end of the side wall need not be geometrically circular.

As mentioned above, in one preferred embodiment the segment of the wall surface has one of a frustoconical shape and a concave shape, and an elliptical side wall or an elliptical side wall section of the side wall is connected to the bottom wall. This particular combination of shapes both promotes mixing of the foodstuff material during processing through the establishment of non-uniform flow directions within the processed foodstuff material, and facilitates the subsequent removal of processed foodstuff material from the receptacle. In a second aspect the present invention provides a blender comprising a receptacle having a bottom wall and a side wall extending about a longitudinal axis of the receptacle, the side wall defining an opening through which foodstuff material is introduced to the receptacle, the bottom wall comprising a wall surface having a segment with one of a frustoconical shape, a faceted shape, a convex shape and a concave shape, the shape of the segment of the wall surface having an axis of symmetry which is inclined relative to the longitudinal axis of the receptacle so that an end of the segment which adjoins the side wall has a substantially circular shape; and a rotatable tool comprising a processing member for engaging foodstuff material, the processing member being located within the receptacle adjacent to the segment of the wall surface. The open end of the segment of the wall surface thus has a different aspect ratio to the cross-section of the part of the side wall which is connected to the bottom wall. The open end of the segment of the wall surface is preferably at least partially circular, and is more preferably substantially circular.

The segment of the wall surface preferably has a depth as measured in a direction which extends along the axis of symmetry, and a width as measured in a direction which is orthogonal to the axis of symmetry. For a segment having one of a concave shape and a frustoconical shape which is arranged to have a substantially circular open end which is contiguous with the side wall, the maximum width will be equal to the diameter of the circular open end. The ratio of the maximum width, w, of the segment of the wall surface to the depth, d, of the segment of the wall surface is preferably in the range from 10:1 to 2:1, more preferably in the range from 5:1 to 2.5:1, and in a preferred embodiment is approximately 3:1.

As mentioned above, the rotational axis of the tool is preferably collinear with the axis of symmetry of the shape of the segment of the wall surface, and so in a third aspect the present invention provides a blender comprising a receptacle having a bottom wall and a side wall which extends about a longitudinal axis of the receptacle, the side wall defining an opening through which foodstuff material is introduced to the receptacle, part of the side wall which is connected to the bottom wall having a cross-section in a plane which is orthogonal to the longitudinal axis, said cross-section having a shape in the form of a convex curve or a convex polygon with a non-unitary aspect ratio, such as an ellipse; and a tool comprising a shaft which preferably passes through an aperture located in the bottom wall of the receptacle, and a processing member for engaging foodstuff material, the processing member being disposed on the shaft such that the processing member is located within the receptacle, the tool being rotatable about a rotational axis which is inclined relative to the longitudinal axis of the receptacle.

The processing member is preferably rotatable about a rotational axis which is collinear with the axis of symmetry of the segment of the wall surface to describe a swept volume. As mentioned above, the swept volume has an outer lateral surface facing the segment of the wall surface, and which preferably increases in width from a proximal portion proximate to, or adjacent to, the rotational axis to a distal portion remote from the rotational axis. At least the distal portion of this lateral surface preferably has a shape which is substantially the same as that of an adjacent facing portion of the segment of the wall surface. In a preferred embodiment, the outer lateral surface of the lower blade section is located within a plane which intersects the rotational axis of the tool at an angle in the range from 40 to 50°, preferably 45°.

In the example where the segment of the wall surface has a frustoconical shape with a cone angle of 90°, and with an axis of symmetry which is inclined to the longitudinal axis of the receptacle by an angle of 45°, a cross-section of the swept volume, when viewed in a plane which extends through and contains both the longitudinal axis of the receptacle and the rotational axis of the tool, preferably has a first section which has a lateral surface which is substantially orthogonal to the longitudinal axis of the receptacle, and a second section which has a lateral surface which is substantially parallel to the longitudinal axis of the receptacle. With this arrangement of the tool, during processing the tool is able to sweep up foodstuff material which has collected on the horizontal section of the segment of the wall surface, and to sweep foodstuff material from the vertical section of the segment of the wall surface, thereby further promoting the mixing and movement of the blend.

In a fourth aspect the present invention provides a blender comprising a receptacle and a tool located within the receptacle. The receptacle has a bottom wall, a side wall defining an opening through which foodstuff material is introduced to the receptacle, and a longitudinal axis about which the side wall is disposed. The tool comprises a processing member for engaging foodstuff material, the processing member being located within the receptacle adjacent to a wall surface of the bottom wall, and extending outwardly from a rotational axis which passes through the bottom wall and which is inclined relative to the longitudinal axis of the receptacle. The tool is rotatable about the rotational axis to describe a swept volume. The swept volume has a cross-section defined by the intersection of the swept volume with a plane which extends through and contains both the longitudinal axis of the receptacle and the rotational axis of the tool, and wherein the cross-section has a first section which has a lateral surface which is substantially orthogonal to the longitudinal axis of the receptacle, and a second section which has a lateral surface which is substantially parallel to the longitudinal axis of the receptacle.

Preferably, the tool comprises a shaft which passes through an aperture located in the bottom wall. The aperture is spaced from the longitudinal axis of the receptacle, and lies on the axis of symmetry of the shape of the segment of the wall surface. The aperture is preferably located at the centre of the bottom wall; the shape of the bottom wall being such that its centre is spaced from the longitudinal axis of the receptacle.

The shaft is collinear with the rotational axis of the tool. The processing member is preferably connected to the shaft. The processing member may comprise one of a number of different devices for performing a particular process, such as one or more of blending, cutting, whisking, aerating, beating, pulverizing and grinding a variety of foodstuff materials, but in a preferred embodiment the processing member comprises at least one blade which describes the swept volume of the tool. The tool may comprise a single blade, but in a preferred embodiment the tool comprises a plurality of blades. The plurality of blades preferably comprises one or more pairs of diametrically opposed blades, each blade within a respective pair of blades having substantially the same shape.

The, or each, blade preferably comprises a lower blade section which extends outwardly relative to the rotational axis, and an upper blade section which is inclined relative to the lower blade section. Each blade section preferably comprises a respective cutting edge. Each cutting edge is preferably defined by a bevel formed on an edge of a lateral surface of the blade section.

The outer lateral surface of the swept volume is defined by the rotation of the lower blade section about the rotational axis. The lower blade section thus has an outer lateral surface which faces the curved segment of the wall surface of the bottom wall. At least the distal portion of the outer lateral surface of the swept volume preferably has substantially the same shape as an annular section of the segment of the wall surface that faces the distal portion of outer lateral surface of the swept volume. For example, where the segment of the wall surface has a frustoconical shape with a cone angle of α, then the outer lateral surfaces of the lower blade sections are preferably straight and mutually inclined at angle α. On the other hand, where the curved segment of the wall surface is concave in shape, then the outer lateral surface of the lower blade section preferably has the same curvature as the segment of the wall surface.

Each upper blade section is preferably connected to the end of a respective lower blade section. The joints between the upper blade sections and the lower blade sections of the tool are preferably located in a plane containing the open end of the segment of the wall surface of the bottom wall. As a result, the segment of the wall surface lies beneath a volume swept by the upper blade sections during rotation of the tool about the rotational axis.

The shape of the upper blade sections is selected to improve blending performance within the portion of the receptacle lying above the segment of the wall surface of the bottom wall. In general, each upper blade section preferably extends from its respective lower blade section in a direction extending away from the bottom wall of the receptacle. Preferably, the directions in which the upper blade sections extend away from the lower blade sections intersect the rotational axis of the tool, preferably at a common point. In the preferred embodiment, in which the segment of the wall surface of the bottom wall has one of a frustoconical shape and a concave shape, and the part of the side wall which is connected to the bottom wall has an elliptical shape, for each blade the upper section is arranged substantially orthogonal to an adjoining part of the lower blade section. Thus, the upper blade sections may lie in mutually perpendicular planes. The ratio of the distance, W1, between the ends of the upper blade sections which are connected to the lower blade sections to the distance, W2, between the tips of the upper blade sections is preferably lower than 2:1, and is preferably in the range from 1.1:1 to 2:1, more preferably in the range from 1.2:1 to 1.5:1.

In the example where an elliptical side wall or an elliptical side wall section is connected to the bottom wall of the receptacle, a cross-section of a volume swept by the upper sections of the blades, when viewed in a plane which extends through and contains both the longitudinal axis of the receptacle and the rotational axis of the tool, preferably has a third section which is substantially parallel to the longitudinal axis of the receptacle, and a fourth section which is substantially orthogonal to the longitudinal axis of the receptacle. The third section of the swept volume is preferably connected to, and orthogonal to, the first section of the swept volume, and the fourth section of the swept volume is preferably connected to, and orthogonal to, the second section of the swept volume.

Each blade section preferably comprises an inner lateral surface located on the opposite side of the blade section to the outer lateral surface. The inner later surface preferably faces towards the rotational axis of the tool. The cutting edge of the lower blade section is preferably defined by a bevel formed on a leading edge of the outer lateral surface of the lower blade section. The cutting edge of the upper blade section is preferably defined by a bevel formed on a leading edge of the inner lateral surface of the upper blade section. In a fifth aspect, the present invention provides a blender comprising a receptacle and a tool located within the receptacle. The receptacle has a bottom wall, a side wall defining an opening through which foodstuff material is introduced to the receptacle, and a longitudinal axis about which the side wall is disposed. The tool comprises at least one blade having a lower blade section which extends outwardly relative to a rotational axis of the tool, and an upper blade section which is inclined relative to the lower blade section. The rotational axis is inclined relative to the longitudinal axis of the receptacle. Each blade section has a leading edge, a trailing edge, an outer lateral surface and an inner lateral surface. The outer lateral surface of the lower blade section faces the bottom wall, and comprises a bevel extending along its leading edge to define a cutting edge of the lower blade section. The inner lateral surface of the upper blade section faces the rotational axis of the tool, and comprises a bevel extending along its leading edge to define a cutting edge of the upper blade section.

Additional blades or pairs of blades may be provided along the shaft of the tool.

The wall surface of the bottom wall may comprise one or more further segments. For example, depending on the shapes of the side wall(s) and the bottom wall, one or more of such further segments may be disposed between the non-planar segment of the wall surface and the side wall(s). Alternatively, or additionally, one or more of such further segments may be disposed between the non-planar segment of the wall surface and the rotational axis of the tool. In a preferred embodiment in which the non-planar segment of the wall surface has a frustoconical shape, the wall surface comprises a further, planar, preferably annular, segment located between the rotational axis of the tool and the non-planar segment of the wall surface. This further segment preferably lies substantially orthogonal to the rotational axis of the tool.

The blender preferably comprises a base to which the receptacle is detachably connected. The base comprises a motor for rotating the tool about its rotational axis. The shaft is connected to the motor by a coupling assembly. The coupling assembly comprises a first coupling member connected to the motor, and a second coupling member connected to the shaft, and which forms part of the tool. The coupling members mesh together when the receptacle is mounted on the base to allow the tool to be rotated by the motor.

With the receptacle mounted on the base, the outer surface of the bottom wall of the receptacle is preferably supported by an outer surface of the base. The supporting surface of the base is preferably curved, and preferably has a shape which extends about the rotational axis of the drive shaft of the motor. The shape of the supporting surface preferably conforms to the shape of the outer surface of the bottom wall of the receptacle. For example, the supporting surface may have one of a concave shape, a faceted shape, a lobed shape, a conical shape and a frustoconical shape, and preferably has a vertex which lies on the rotational axis of the drive shaft of the motor. In a preferred embodiment, the supporting surface has a frustoconical shape.

The motor has an output shaft which is connected to the first coupling member. The output shaft is preferably collinear with the rotational axis of the tool. In a sixth aspect the present invention provides a blender comprising a base, a receptacle detachably connected to the base, and a tool. The receptacle comprises a bottom wall and a side wall extending about the longitudinal axis of the receptacle, the side wall defining an opening through which foodstuff material is introduced to the receptacle. The tool comprises a shaft which passes through an aperture located in the bottom wall of the shaft, and a processing member disposed on the shaft such that the processing member is located within the receptacle. The tool is rotatable about a rotational axis. The base comprises a motor for rotating the tool about the rotational axis, the motor having an output shaft which is collinear with the rotational axis of the tool, the rotational axis of the tool being inclined to the longitudinal axis of the receptacle by an angle in the range from 15 to 75°.

The first coupling member is preferably located on the rotational axis of the tool. To connect the receptacle to the base, the user moves the receptacle along the rotational axis of the shaft of the motor towards the base so that the second coupling member meshes with the first coupling member. In other words, the receptacle is mounted on the base through moving the receptacle towards the base in a direction which is inclined relative to the longitudinal axis of the receptacle.

The second coupling member is preferably located on, and preferably extends along, the rotational axis of the output shaft of the motor. The second coupling member thus preferably extends in a direction which is inclined relative to the longitudinal axis of the receptacle. In a seventh aspect the present invention provides a blender comprising a base, a receptacle detachably connected to the base, and a tool. The receptacle comprises a bottom wall and a side wall extending about the longitudinal axis of the receptacle, the side wall defining an opening through which foodstuff material is introduced to the receptacle. The tool comprises a shaft which passes through an aperture located in the bottom wall of the shaft, a processing member disposed on the shaft such that the processing member is located within the receptacle, and a first coupling member connected to the shaft. The tool is rotatable about a rotational axis. The base comprises a motor for rotating the tool about the rotational axis, and a second coupling member connected to the motor for engaging the first coupling member to transfer torque from the motor to the tool, the second coupling member being rotatable about an axis which is inclined relative to the longitudinal axis of the receptacle by an angle in the range from 15 to 75°.

Features described above in connection with the first aspect of the invention are equally applicable to each of the second to seventh aspects of the invention, and vice versa.

### BRIEF DESCRIPTION OF THE DRAWINGS

Preferred features of the present invention will now be described by way of example only with reference to the accompanying drawings, in which:

FIG. 1 is a front perspective view, from above, of a blender;

FIG. 2 is a rear perspective view, from above, of the blender;

FIG. 3 is a front view of the blender;

FIG. 4 is a top view of the blender;

FIG. 5(a) is a top view of a receptacle of the blender, and FIG. 5(b) is a sectional view taken along line E-E in FIG. 5(a);

FIG. 6(a) is a top view of a jug of the receptacle, and FIG. 6(b) is a sectional view taken along line H-H in FIG. 6(a);

FIG. 7 is a sectional view taken along line F-F in FIG. 4;

FIG. 8(a) is a side view of the blender with its lid removed, and FIG. 8(b) is a sectional view taken along line G-G in FIG. 8(a);

FIG. 9(a) is a top view of a tool of the blender, and FIG. 9(b) is a sectional view taken along line C-C in FIG. 9(a);

FIG. 10(a) is a first perspective view, from below, of the tool, FIG. 10(b) is a second perspective view, from below, of the tool, FIG. 10(c) is a top side view of the tool, and FIG. 10(d) is a sectional view taken along line D-D in FIG. 10(c);

FIG. 11 is a sectional view taken along line H-H in FIG. 4;

FIG. 12(a) is a side view of the base of the blender, and FIG. 12(b) is a front view of the base;

FIG. 13 is a sectional view, similar to FIG. 11, but with the receptacle detached from the base;

FIG. 14(a) is a top view of a volume swept by a blade member of the tool during use of the blender; and FIG. 14(b) is a top view of the swept volume as positioned relative to the jug of the receptacle during use of the blender;

FIG. 15(a) is a sectional view taken along line J-J in FIG. 14(a), and FIG. 15(b) is a sectional view taken along line L-L in FIG. 14(b); and

FIG. 16(a) is a sectional view taken along line K-K in FIG. 14(a), and FIG. 16(b) is a sectional view taken along line M-M in FIG. 14(b).

### DETAILED DESCRIPTION OF THE INVENTION

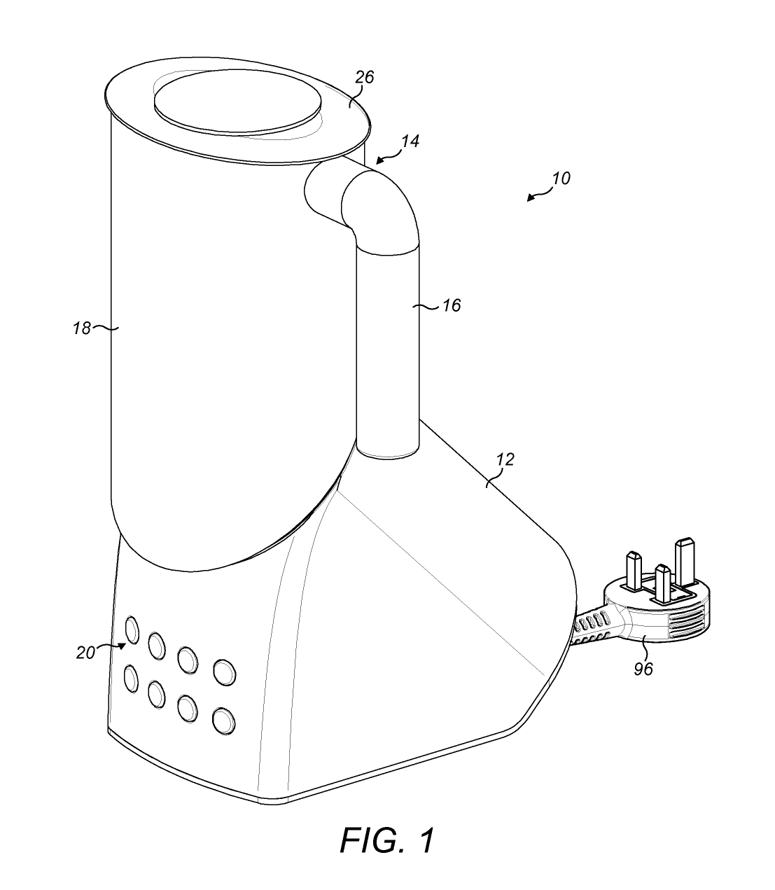

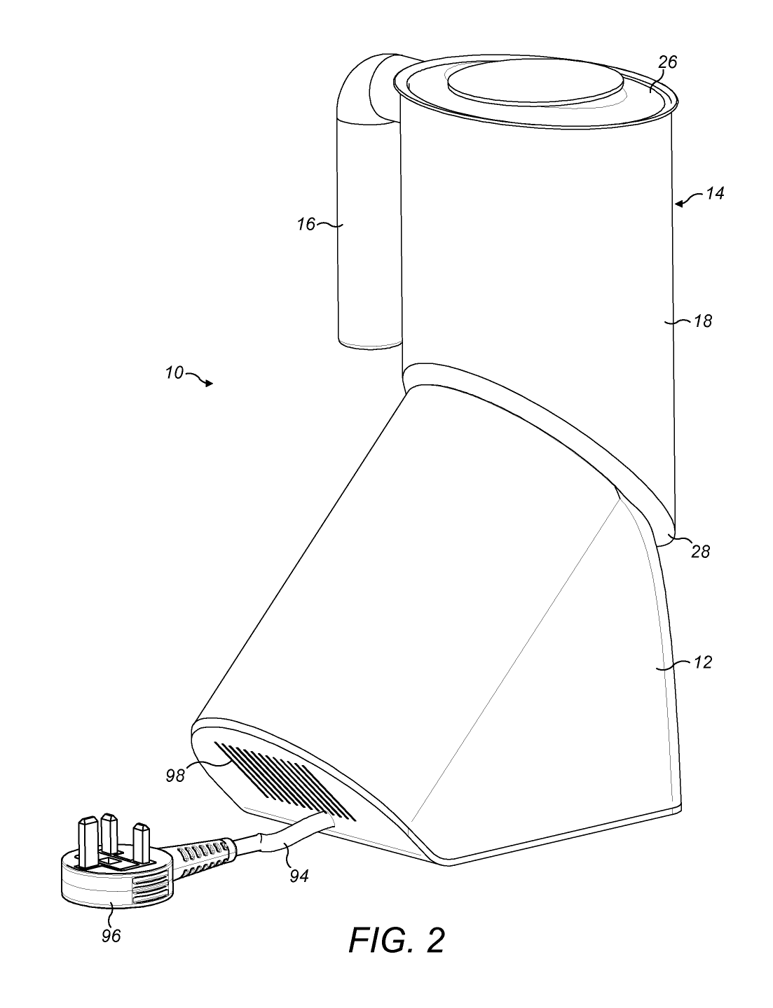

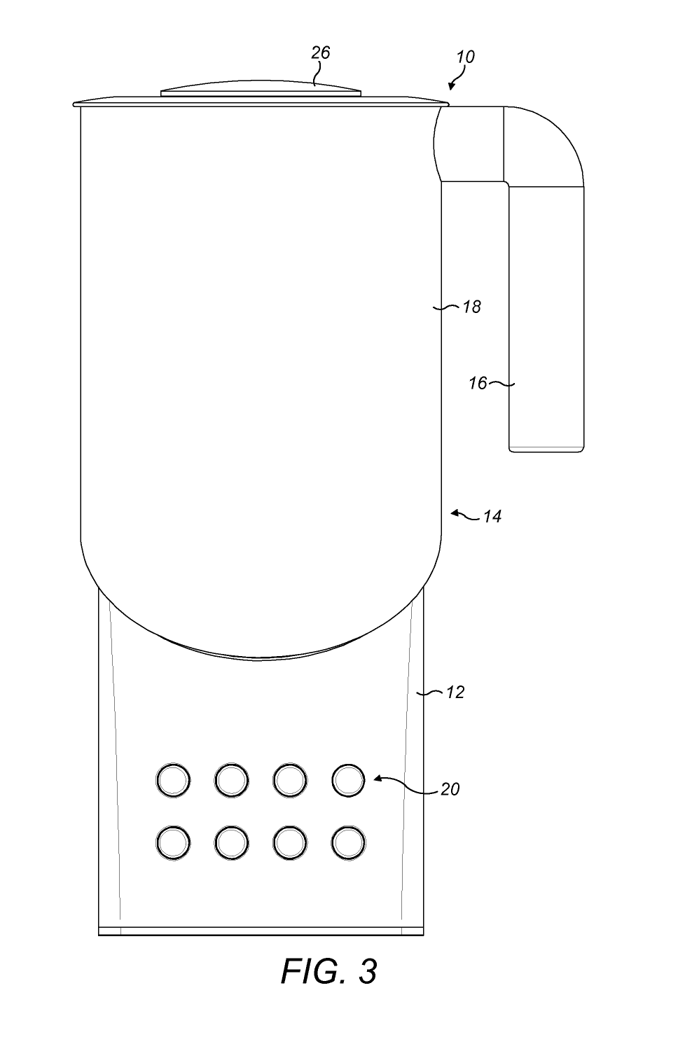

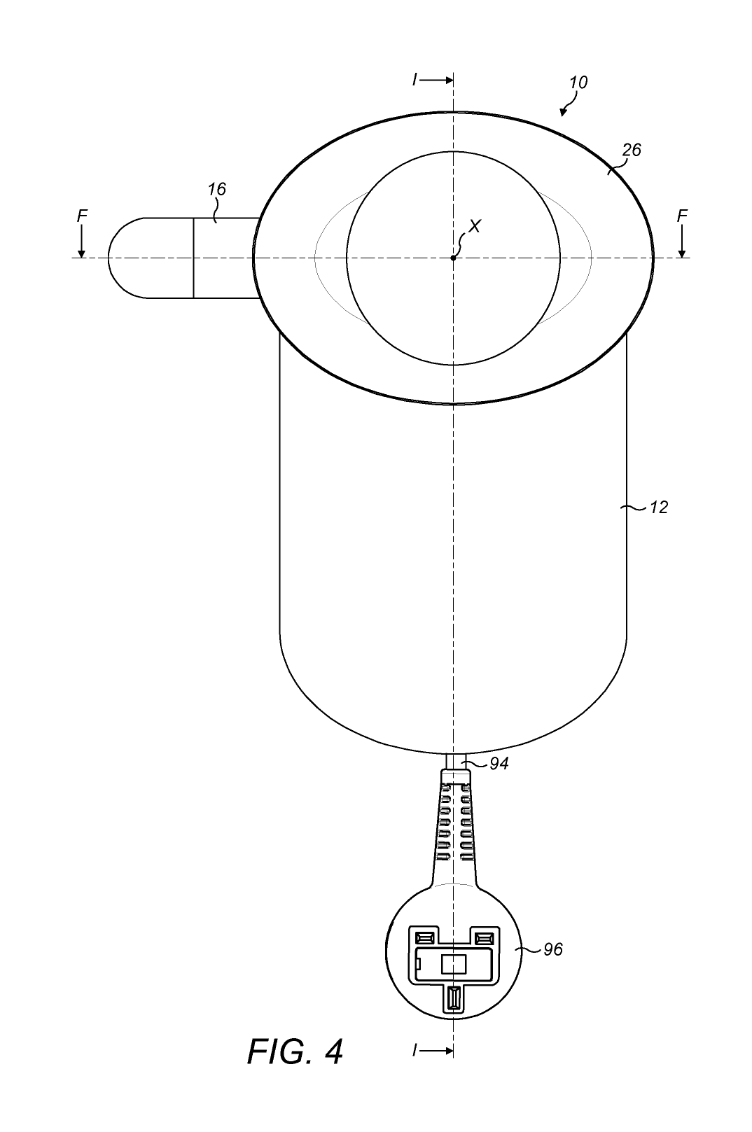

FIGS. 1 to 4 are external views of a domestic blender 10. The blender 10 comprises a base 12 and a receptacle 14 detachably mounted on the base 12. The base 12 is sized so as to be locatable on a work surface, for example of a kitchen. In this example the receptacle 14 comprises a jug having a handle 16 connected to a side wall 18. However, the receptacle 14 may comprise a vessel having a form other than that of a jug, for example through omission of the handle 16. The base 12 comprises a user interface 20 which is operable by the user to control the operation of the blender 10. For example, through the depression of one or more of the buttons of the user interface 20, the user may commence one of a variety of different processes depending, for example, on the nature of the foodstuff material to be processed, and the desired consistency of the processed foodstuff material.

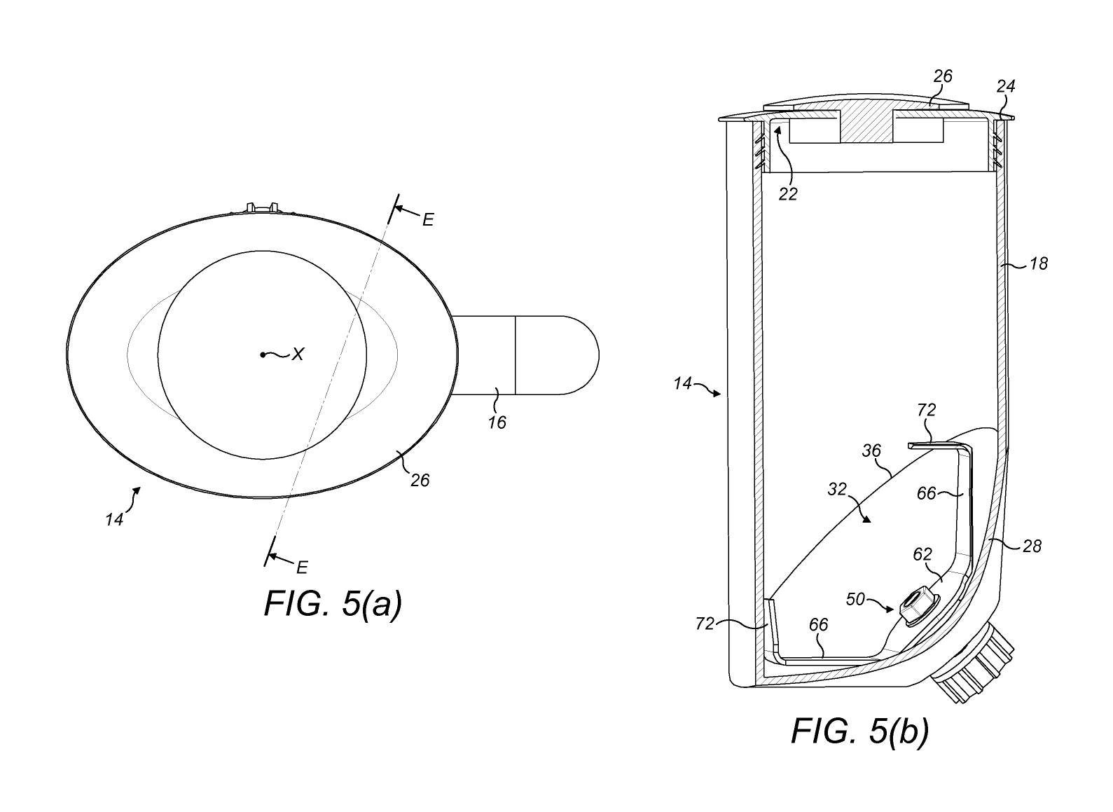

With reference also to FIGS. 5(a) and 5(b), the receptacle 14 has an opening 22 through which foodstuff material is introduced to the receptacle 14, and from which the processed foodstuff material is dispensed from the receptacle 14, for example in the form of a beverage, dip or paste. The opening 22 is defined by the upper end 24 of the side wall 18 of the jug, During processing of the foodstuff material, the opening 22 may be closed by a removable lid 26. As illustrated, the lid 26 may have two parts; a central part removably located within an outer part which is fitted into the opening 22 of the receptacle 14. Depending on the size and shape of the foodstuff material to be processed, the user may remove only the central part of the lid 26 to introduce foodstuff material to the receptacle 14.

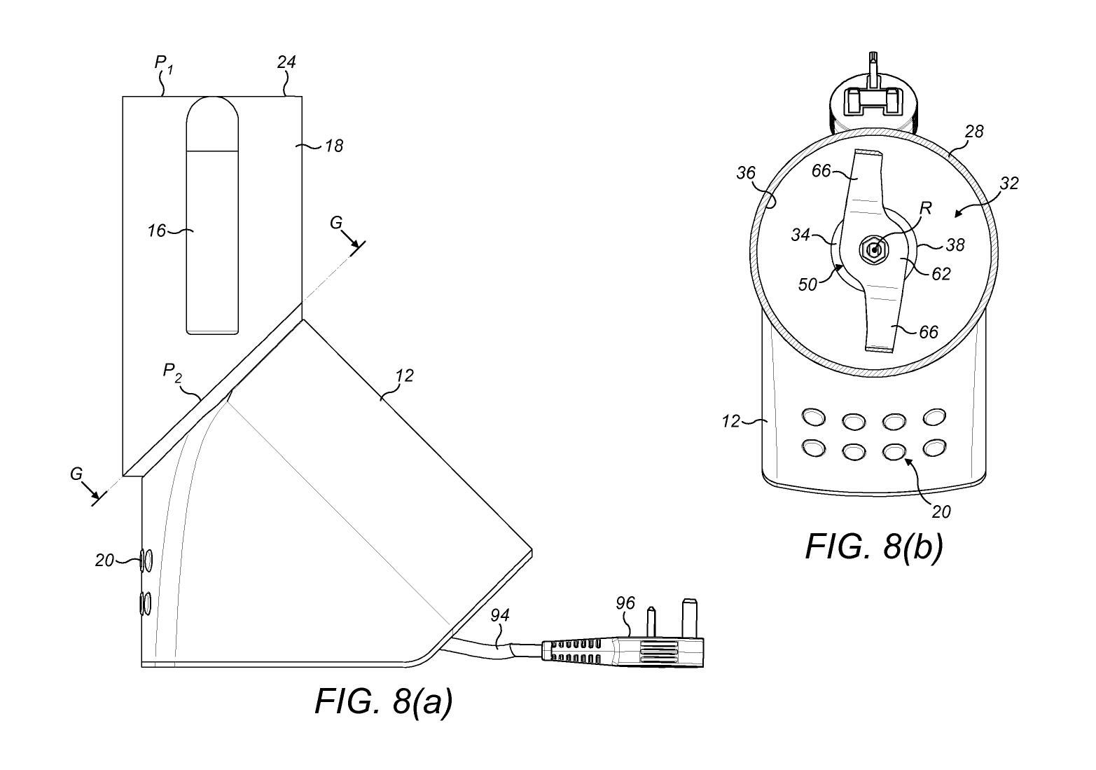

The side wall 18 is tubular in shape, and is aligned so that the longitudinal axis of the side wall 18 is collinear with the longitudinal axis X of the receptacle 14. With the base 12 disposed on a horizontal work surface, the longitudinal axis X is substantially vertical when the receptacle 14 is mounted on the base 12. The side wall 18 has a cross-section which has an elliptical shape in a plane which is orthogonal to the longitudinal axis X of the receptacle 14. The opening 22 of the receptacle 14 is located in such a plane P1, as identified in FIG. 8(a), and so the opening 22 is also elliptical in shape.

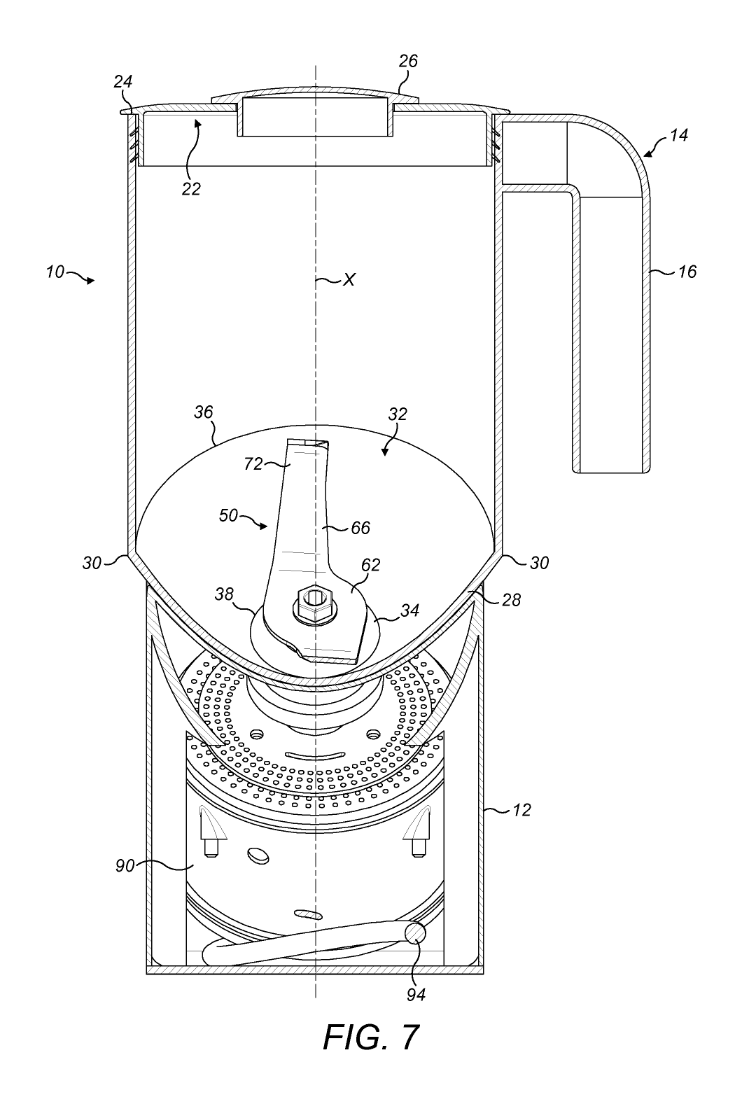

The jug comprises a bottom wall 28 connected to the lower end 30 of the side wall 18. With reference now to FIGS. 5 to 8, the internal wall surface of the bottom wall 28 has two segments; a curved segment 32 and an annular segment 34. The curved segment 32 is preferably continuous, and has an open end 36 adjoining the lower end 30 of the side wall 18. The curved segment 32 has a non-planar, axially symmetrical shape which comprises a vertex V. An axis of symmetry A of the shape of the curved segment 32 passes through the vertex V. In this example, the curved segment 32 has a frustoconical shape with a cone angle α of 90°. The curved segment 32 has a second, relatively narrow end 38 located opposite to its open end 36, and which is substantially parallel to the open end 36. The annular segment 34 of the wall surface of the bottom wall 28 is connected to the relatively narrow end 38 of the curved segment 32.

The curved segment 32 has a depth, d, as measured in a direction extending along the axis of symmetry A, and a maximum width, w, as measured in a direction orthogonal to the axis of symmetry A. The shape of the open end 36 defines the maximum width, w, of the curved segment 32. The ratio of the maximum width, w, of the curved segment 32 to the depth, d, of the curved segment 32 is approximately 3:1.

The lower end 30 of the side wall 18 is located within a plane P2 which is inclined at an angle to both the longitudinal axis of the side wall 18 and the plane P1 which contains the opening 22 of the receptacle 14. The axis of symmetry A of the shape of the curved segment 32 is thus inclined relative to, and intersects, the longitudinal axis X of the receptacle 14, resulting in the vertex V of the shape of the curved segment 32 being spaced from the longitudinal axis X of the receptacle 14. In this example, the plane P2 is inclined at an angle of 45° to the plane P1. As the side wall 18 has an elliptical cross-section, the lower end 30 of the side wall 18 is substantially circular in shape. The open end 36 of the curved segment 32 is thus also substantially circular in shape. The angle of inclination of the axis of symmetry A relative to the longitudinal axis X of the receptacle 14 is thus also approximately 45°. The maximum width of the curved segment 32 is equal to the diameter of the open end 36.

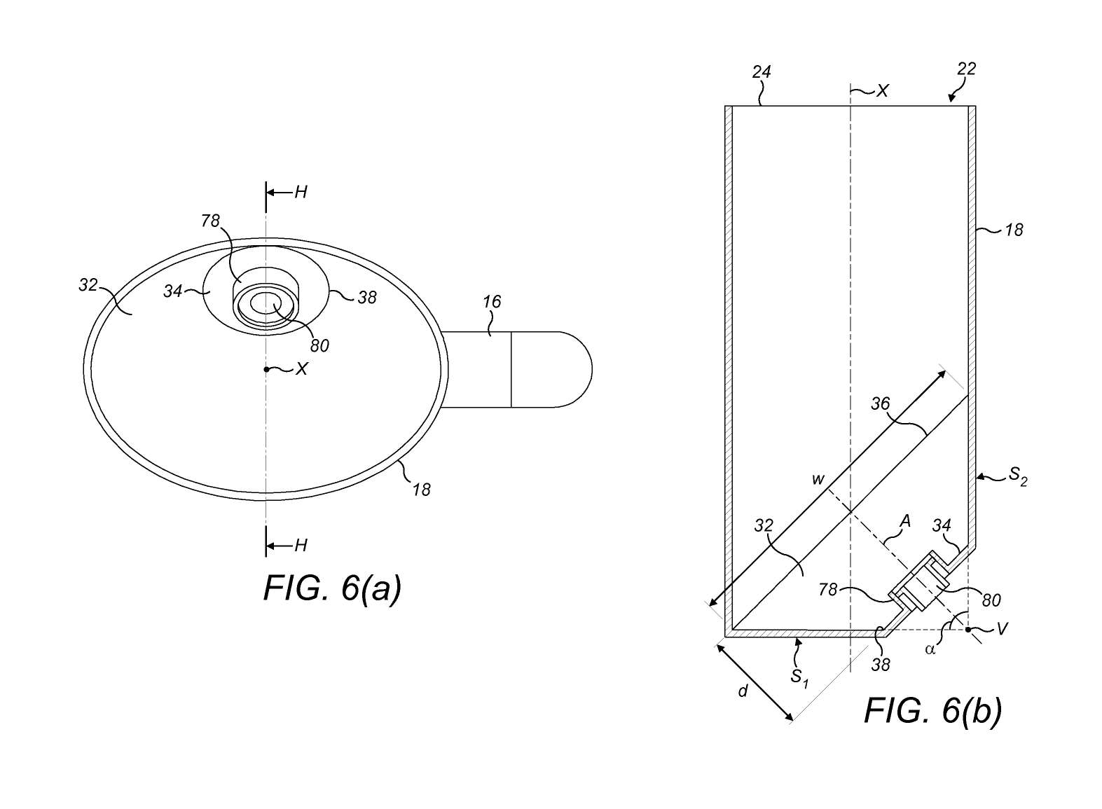

With reference to FIG. 6(b), when viewed in a plane which extends through and contains both the longitudinal axis X of the receptacle 14 and the axis of symmetry A of the shape of the curved segment 32, the curved segment 32 has two sections; a first section S1 lying to one side of the axis of symmetry A and a second section S2 lying to the other side of the axis of symmetry A. Due to the symmetry of the curved segment 32, the second section S2 is a mirror image of the first section S1. In this example in which the curved segment 32 has a frustoconical shape with a 90° cone angle, the first section S1 is substantially orthogonal to the longitudinal axis X of the receptacle 14, and the second section S2 is substantially parallel to the longitudinal axis X of the receptacle 14. With the longitudinal axis X of the receptacle 14 in a vertical orientation, the curved segment 32 may be considered to sweep upwardly about the axis of symmetry A from a horizontal first section S1 to a vertical second section S2, and to sweep downwardly about the axis of symmetry A from the second section S2 back to the first section S1.

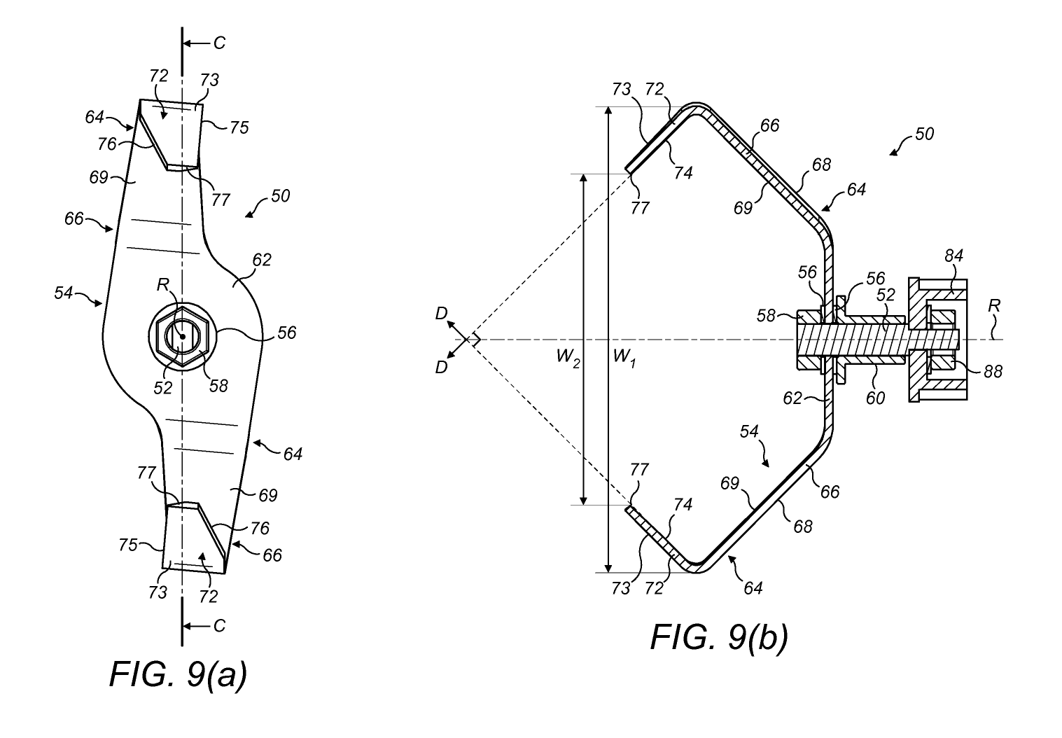

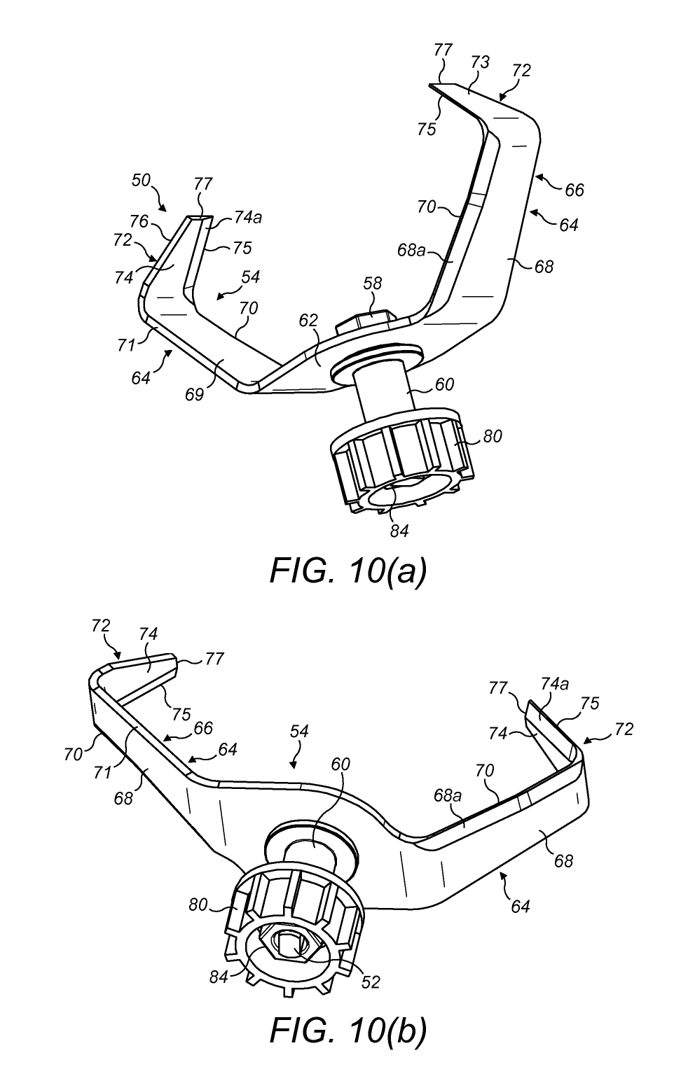

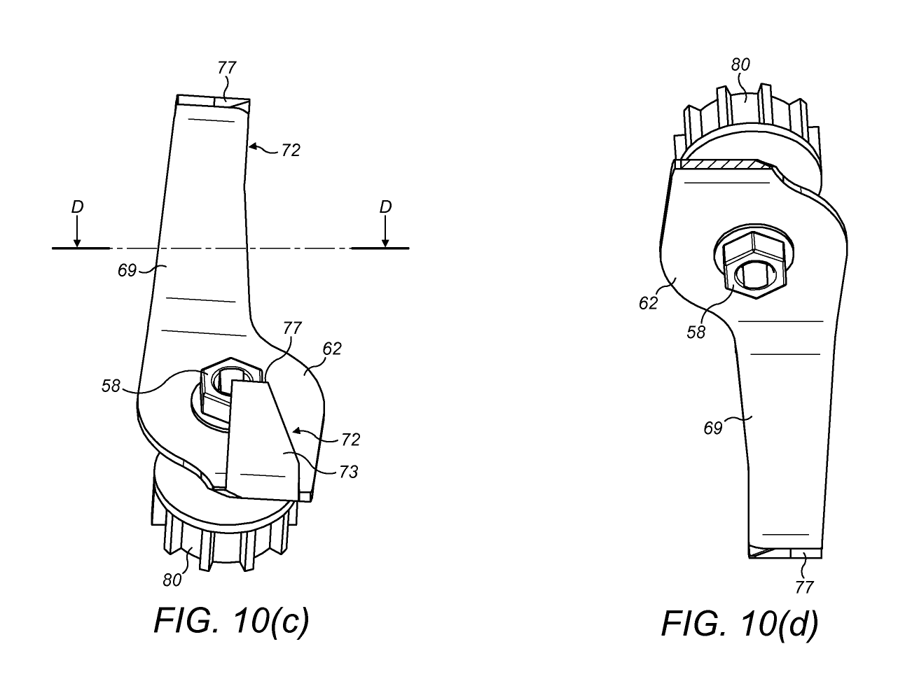

The blender 10 comprises a tool 50 for processing foodstuff material introduced into the receptacle 14. In this example, the tool 50 is connected to the jug, and is supported so as to be rotatable relative to the jug. In FIGS. 9 and 10, the tool 50 is illustrated in isolation from other parts of the receptacle 14. The tool 50 is rotatable about a rotational axis R. The tool 50 comprises a shaft 52 which has a longitudinal axis which is collinear with the rotational axis R of the tool. A processing member, in this embodiment in the form of a bladed member 54, is mounted on the shaft 52. The bladed member 54 is sandwiched between a pair of washers 56, which are in turn located between a first nut 58 secured to one end of the shaft 52, and a plain bearing 60 which extends about a central part of the shaft 52.

The shaft 52 extends through a central hub 62 of the bladed member 54. The bladed member 54 comprises a pair of diametrically opposed blades 64 connected to the central hub 62. Each blade 64 comprises a lower blade section 66 connected to the central hub 62, and which extends outwardly relative to the rotational axis R of the tool 50. In this example, each lower blade section 66 is generally flat, and is inclined at an angle of 45° to the rotational axis R of the tool 50 so that the lower blade sections 66 are mutually perpendicular. Each lower blade section 66 has an outer lateral surface 68 and an inner lateral surface 69 located opposite to the outer lateral surface 68 and which faces towards the rotational axis R of the tool. The outer lateral surface 68 is generally planar in shape, and is contained within a plane which intersects the rotational axis R of the tool at an angle of approximately 45°. Each lower blade section 66 has a leading edge 70 and a trailing edge 71. A bevel 68a formed on the outer lateral surface 68 forms a cutting edge extending along the leading edge 70 of the lower blade section 66.

Each blade 64 further comprises an upper blade section 72 which is connected to the lower blade section 66. In this example, each upper blade section 72 is generally flat, and is disposed perpendicular to the lower blade section 66 so that the upper blade sections 72 extend away from the lower blade sections 66 in directions D which are mutually orthogonal and which intersect the rotational axis R of the tool 50 at a common point. Each upper blade section 72 has an outer lateral surface 73 and an inner lateral surface 74 located opposite to the outer lateral surface 73 and which faces towards the rotational axis R of the tool. The outer lateral surface 73 is generally planar in shape, and is contained within a plane which intersects the rotational axis R of the tool at an angle of approximately 45°. Each upper blade section 72 has a leading edge 75 and a trailing edge 76. A bevel 74a formed on the inner lateral surface 74 forms a cutting edge extending along the leading edge 75 of the upper blade section 72.

Each upper blade section 72 is shorter than its respective lower blade section 66. The length of the upper blade sections 72 are preferably such that the ratio of the distance, W1, between the ends of the upper blade sections 72 which are connected to the lower blade sections 66 to the distance, W2, between the tips 77 of the upper blade sections 72 is preferably lower than 2:1, and is preferably in the range from 1.1:1 to 2:1, more preferably in the range from 1.2:1 to 1.5:1.

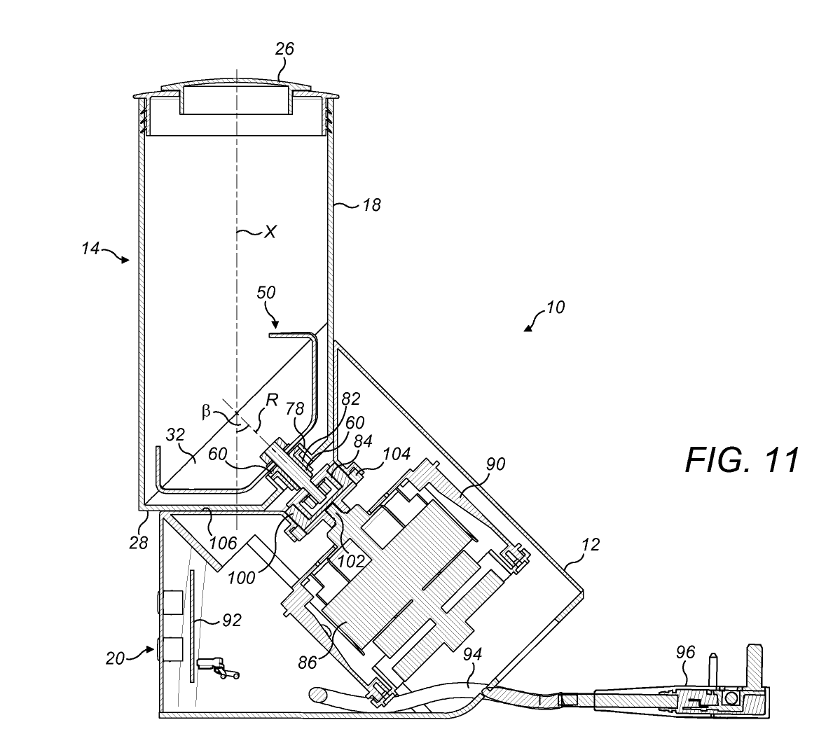

With reference again to FIGS. 5 to 11, the annular segment 34 of the wall surface of the bottom wall 28 comprises a cylindrical section 78 which defines a circular aperture 80 centered on the axis of symmetry A. The bottom wall 28 comprises a tubular sleeve 82 which is disposed within the aperture 80. During assembly of the receptacle 14, the shaft 52 of the tool 50 is pushed through the sleeve 82 so that the plain bearing 60 is retained by the sleeve 82. A first coupling member 84 which forms part of a coupling assembly for coupling the shaft 52 to a motor 86 is then secured to the shaft 52 by a nut 88.

With the tool 50 secured to the receptacle 14, the bladed member 54 is disposed such that the lower blade sections 66 of the blades 64 are located within the receptacle 14 adjacent to the curved segment 32 of the wall surface of the bottom wall 28, and such that the outer lateral surfaces 68 of the lower blade sections 66 face, but are spaced from, the curved segment 32 of the wall surface of the bottom wall 28. The rotational axis R of the tool 50 is aligned relative to the receptacle 14 so that it is collinear with the axis of symmetry A of the shape of the curved segment 32 of the wall surface of the bottom wall 28. Consequently, the rotational axis R of the tool 50 is inclined to the longitudinal axis X of the receptacle 14, and intersects the longitudinal axis X of the receptacle 14 at an angle of 45°. The joints between the upper blade sections 72 and the lower blade sections 66 of the tool 50 are located substantially in the plane P2 containing the lower end 30 of the side wall 18.

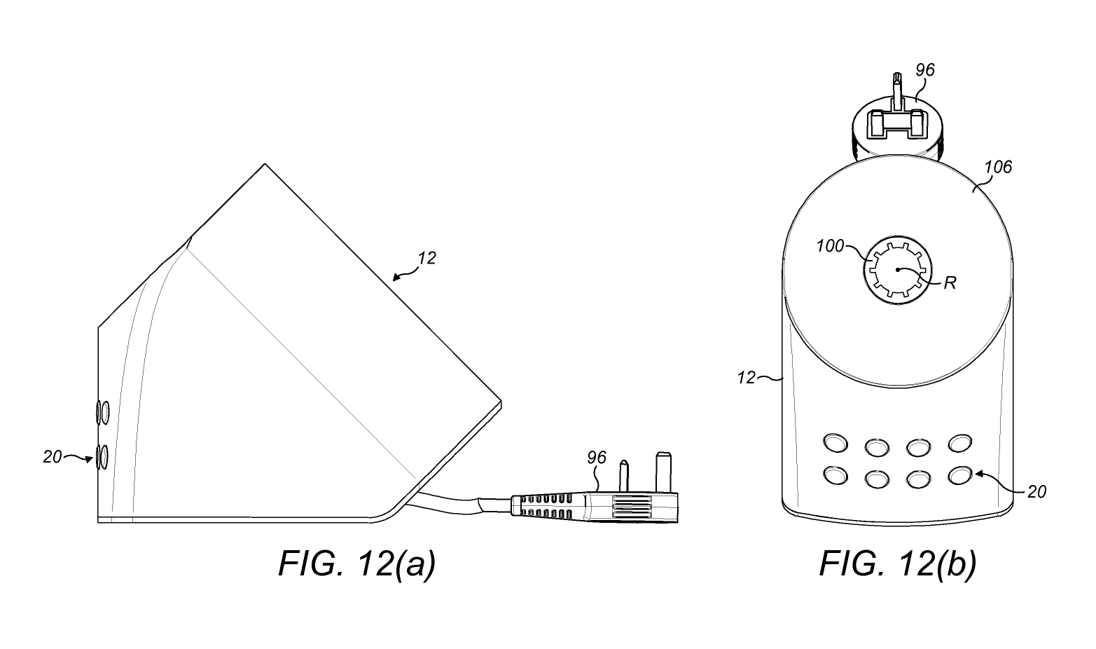

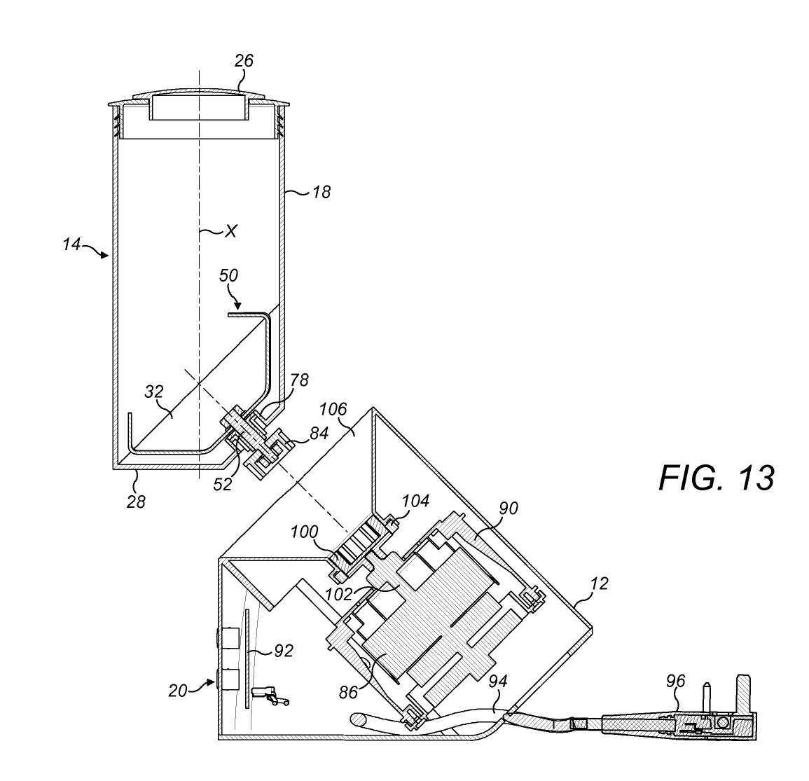

The motor 86 is located within the base 12 of the blender 10. With reference also to FIGS. 12 and 13, the motor 86 is housed within a motor bucket 90 secured to the base 12. The motor 86 is connected by a cable (not shown) to a control circuit 92 which is also located within the base 12. The user interface 20 is connected to the control circuit 92, either directly or through an intermediate user interface control circuit. The control circuit 92 is connected to a power cable 94 for supplying power to the control circuit. A plug 96 for insertion into a socket is connected to the end of the power cable 94. Vents 98 are formed in the base 12 to allow air to pass through the base 12 during use of the blender 10. A second coupling member 100 is connected to the drive shaft 102 of the motor 86. The second coupling member 100 is supported by a bearing 104 for rotation relative to the base 12.

To connect the receptacle 14 to the base 12, the user moves the receptacle 14 along the rotational axis of the drive shaft 102 of the motor 86, that is, in a direction which is inclined to the longitudinal axis X of the receptacle 14, to bring the first coupling member 84 into engagement with the second coupling member 100. When the receptacle 14 is mounted on the base 12, the coupling members 84, 100 mesh together to connect the tool 50 to the motor 86 to allow torque to be transferred from the motor 86 to the tool 50. The base 12 comprises a supporting surface 106 for supporting the bottom wall 28 of the receptacle 14 when the receptacle 14 is connected to the base 12. The supporting surface 106 is preferably curved, and preferably has a shape which extends about the rotational axis of the drive shaft 102 of the motor 86. The shape of the supporting surface 106 preferably conforms to the shape of the outer surface of the bottom wall 28 of the receptacle 14. For example, the supporting surface 106 may have one of a concave shape, a faceted shape, a lobed shape, a conical shape and a frustoconical shape which has a vertex which lies on the rotational axis of the drive shaft 102 of the motor 86. In this example the supporting surface 106 has a frustoconical shape. To subsequently remove the receptacle 14 from the base 12, the user simply pulls the receptacle 14 away from the base 12 in a direction extending along the rotational axis of the drive shaft 102 of the motor 86 to decouple the coupling members 84, 100.

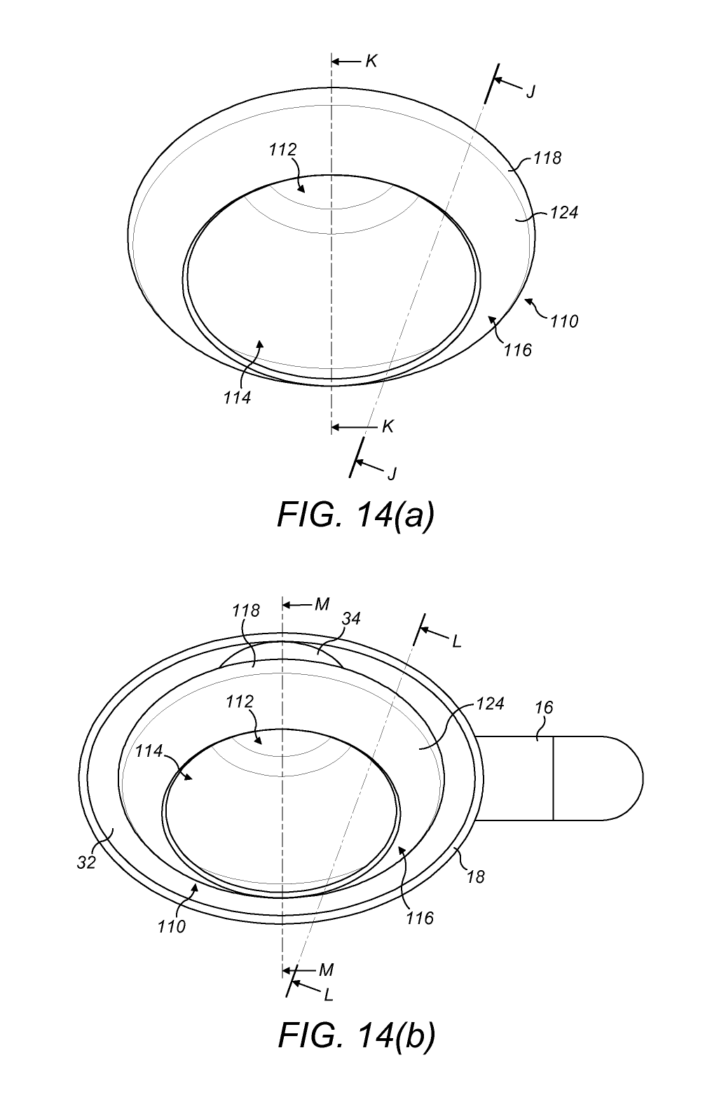

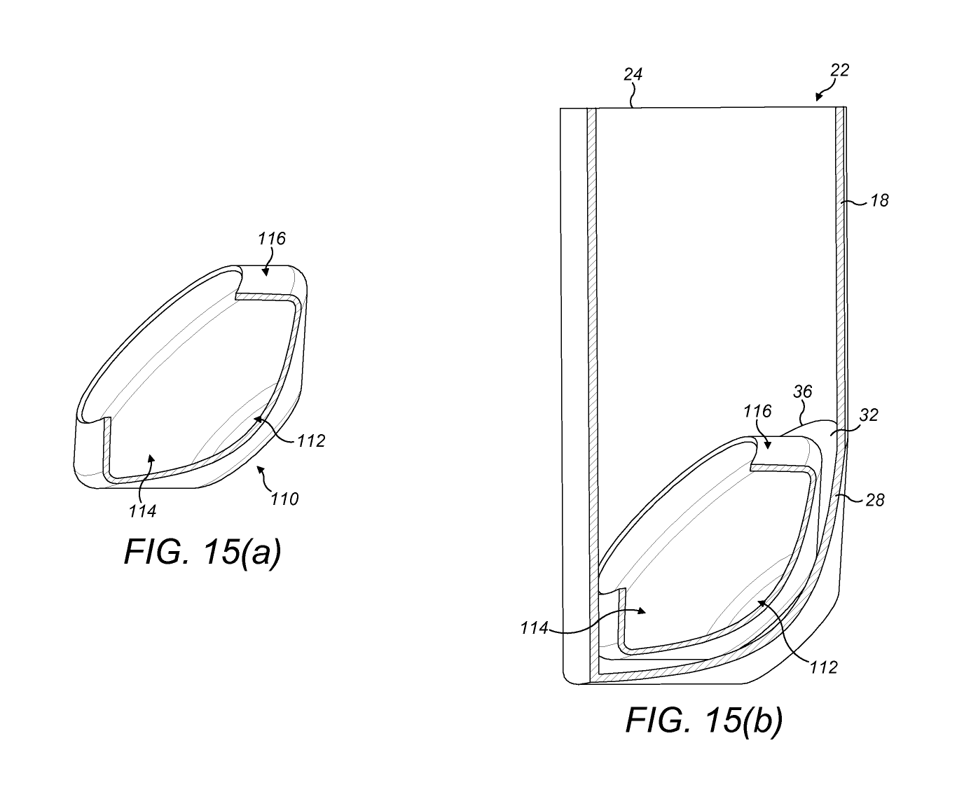

In use, a user depresses an appropriate button of the user interface 20 to activate the motor 86 to rotate the tool 50 to process foodstuff material introduced to the receptacle 14. As the bladed member 54 rotates about the rotational axis R of the tool 50, it describes a swept volume 110, as illustrated in FIGS. 14 to 16. The swept volume 110 has a number of segments which are described by different parts of the bladed member 54. In this example, the swept volume 110 has an annular segment 112 which is described by the central hub 62 of the bladed member 54, a first frustoconical segment 114 which is described by the lower blade sections 66 of the bladed member 54, and a second frustoconical segment 116 which is described by the upper blade sections 72 of the bladed member 54.

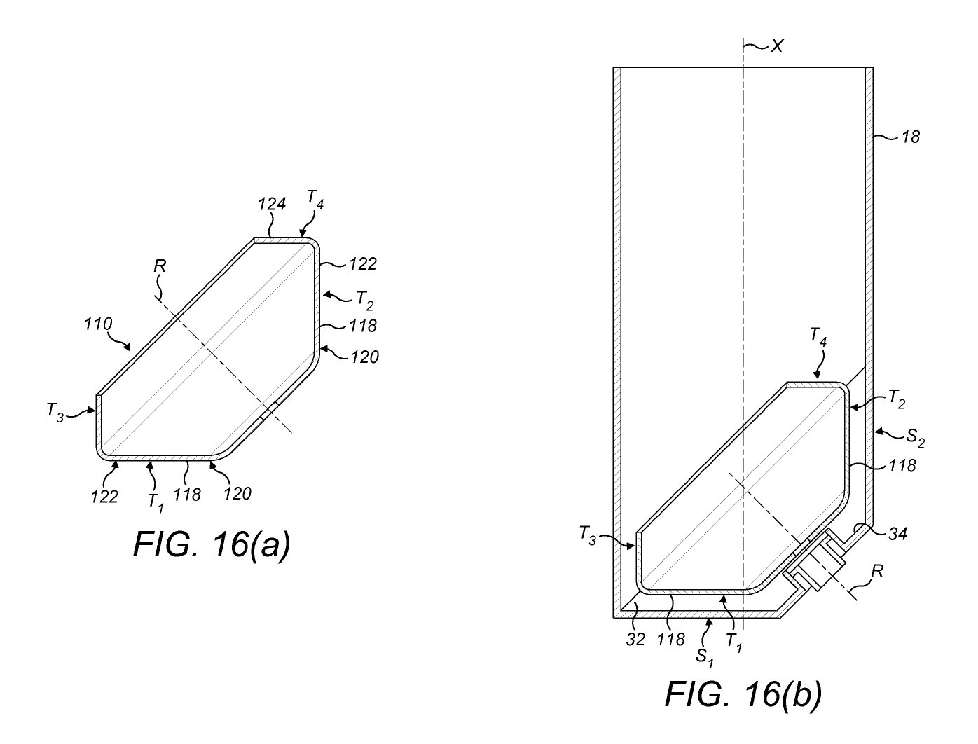

The first frustoconical segment 114 of the swept volume 110 has an outer lateral surface 118 which faces towards the curved segment 32 of the wall surface 28. The shape of this outer lateral surface 118 is determined by the shape of the outer lateral surface 68 of the lower blade sections 66. This outer lateral surface 118 thus tapers outwardly, relative to the rotational axis R of the tool 50, from the annular segment 112 of the swept volume 110. As illustrated in FIGS. 16(a) and 16(b), the outer lateral surface 118 has a width, as measured in a direction which is orthogonal to the rotational axis R of the tool 50, which increases in size from a proximal portion 120, located proximate, or adjacent, to the rotational axis R of the tool 50, to a distal portion 122 located remote from the rotational axis R of the tool 50. At least the distal portion 122 of the outer lateral surface 118, and in this example substantially the entire outer lateral surface 118, has a shape which is substantially the same as that of the adjacent facing portion of the curved segment 32 of the wall surface of the bottom wall 28 of the jug. To avoid clashing between the tool 50 and the curved segment 32 of the wall surface during rotation of the tool 50, the size of the outer lateral surface 118 of the first frustoconical segment 114 of the swept volume 110 is slightly smaller than that of the curved segment 32 of the wall surface so that the outer lateral surface 118 is surrounded by the curved segment 32 of the wall surface. At any point along the curved segment 32 of the wall surface, the radial distance between the curved segment 32 of the wall surface and the outer lateral surface 118 is preferably no greater than 10 mm, and is more preferably between 1 and 10 mm.

As illustrated in FIGS. 16(a) and 16(b), when viewed in a plane which extends through and contains both the longitudinal axis X of the receptacle 14 and the rotational axis R of the tool 50, the first frustoconical segment 114 of the swept volume 110 comprises a first section T1 located adjacent to the first section S1 of the curved segment 32 of the wall surface, and a second section T2 located adjacent to the second section S2 of the curved segment 32 of the wall surface. In this example where the curved segment 32 of the wall surface has a frustoconical shape with a cone angle of 90°, and with an axis of symmetry A which is inclined to the longitudinal axis of the receptacle by an angle of 45°, the outer lateral surface 118 of each section T1, T2 of the first frustoconical segment 114 of the swept volume 110 is substantially parallel to, but spaced from, an adjacent facing portion of its respective section S1, S2 of the curved segment 32 of the wall surface. In other words, the first frustoconical segment 114 of the swept volume 110 has a first section T1 which has an outer lateral surface 118 which is substantially orthogonal to the longitudinal axis X of the receptacle 14, and a second section T2 which has an outer lateral surface 118 which is substantially parallel to the longitudinal axis X of the receptacle 14.

The second frustoconical segment 116 of the swept volume 110 has an outer lateral surface 124 which faces away from the curved segment 32 of the wall surface 28. The shape of this outer lateral surface 124 is determined by the shape of the outer lateral surface 73 of the upper blade sections 72. This outer lateral surface 124 thus tapers inwardly, relative to the rotational axis R of the tool 50, from the distal portion 120 of the first frustoconical segment 114 of the swept volume 110. As mentioned above, the joints between the upper blade sections 72 and the lower blade sections 66 of the tool 50 are located substantially in the plane P2 containing the lower end 30 of the side wall 18. As a result, the second frustoconical segment 116 of the swept volume 110 lies above the plane P2, and thus above the curved segment 32 of the wall surface.

In this example, when viewed in the aforementioned plane which extends through and contains both the longitudinal axis X of the receptacle 14 and the rotational axis R of the tool 50, the second frustoconical segment 116 of the swept volume 110 has a first section T3 which is substantially parallel to the longitudinal axis X of the receptacle 14, and a second section T4 which is substantially orthogonal to the longitudinal axis X of the receptacle 14. The first section T3 is connected to, and substantially orthogonal to, the first section T1 of the swept volume described by the lower blade sections 66, and the second section T4 is connected to, and orthogonal to, the second section T2 of the swept volume described by the lower blade sections 66.

In summary, a blender includes a receptacle and a tool located within the receptacle. The receptacle has a bottom wall, a side wall defining an opening through which foodstuff material is introduced to the receptacle, and a longitudinal axis about which the side wall extends. A wall surface of the bottom wall includes a curved segment having a shape with a vertex which is spaced from the longitudinal axis of the receptacle. The tool is located within the receptacle adjacent to the curved segment of the wall surface. The tool is rotatable about the rotational axis. The rotational axis preferably passes through the vertex and is inclined relative to the longitudinal axis of the receptacle.

1. A blender comprising:
a receptacle having a bottom wall, a side wall defining an opening through which foodstuff material is introduced to the receptacle, and a longitudinal axis about which the side wall is disposed; and
a tool comprising a processing member located within the receptacle adjacent to the bottom wall, and which extends outwardly from a rotational axis of the tool, the rotational axis passing through the bottom wall and being inclined relative to the longitudinal axis of the receptacle;
wherein the processing member is rotatable about the rotational axis to describe a swept volume having a cross-section defined by the intersection of the swept volume with a plane which extends through and contains both the longitudinal axis of the receptacle and the rotational axis of the tool, and wherein the cross-section has a first section which has a lateral surface which is substantially orthogonal to the longitudinal axis of the receptacle, and a second section which has a lateral surface which is substantially parallel to the longitudinal axis of the receptacle.

2. The blender of claim 1, wherein the tool comprises a shaft which passes through an aperture located in the bottom wall, and wherein the shaft is collinear with the rotational axis of the tool.

3. The blender of claim 2, wherein the aperture is spaced from the longitudinal axis of the receptacle.

4. The blender of claim 2, wherein the processing member is connected to the shaft.

5. The blender of claim 1, wherein the processing member comprises at least one blade which describes the swept volume of the tool.

6. The blender of claim 5, wherein the, or each, blade comprises a lower blade section which extends outwardly relative to the rotational axis, and an upper blade section which is inclined relative to the lower blade section.

7. The blender of claim 6, wherein the lateral surface of the swept volume is defined by the rotation of the lower blade section about the rotational axis.

8. The blender of claim 6, wherein the upper blade section is connected to the end of the lower blade section.

9. The blender of claim 8, wherein a joint between the upper blade section and the lower blade section is located in a plane containing a lower end of the side wall.

10. The blender of claim 6, wherein the upper blade section extends from the lower blade section in a direction extending away from the bottom wall of the receptacle.

11. The blender of claim 10, wherein the direction in which the upper blade section extends away from the lower blade section intersects the rotational axis of the tool.

12. The blender of claim 6, wherein the upper section is arranged substantially orthogonal to an adjoining part of the lower blade section.

13. The blender of claim 6, wherein the cross-section has a third section connected to the first section which has a lateral surface which is substantially parallel to the longitudinal axis of the receptacle, and a fourth section which has a lateral surface which is substantially orthogonal to the longitudinal axis of the receptacle, and wherein the third section and the fourth section are described by the upper blade section.

14. The blender of claim 13, wherein the ratio of the distance between the ends of the third and fourth sections which are connected to first and second sections, respectively, to the distance between the tips of the third and fourth sections is preferably lower than 2:1.

15. The blender of claim 14, wherein said ratio is in the range from 1.1:1 to 2:1.

16. The blender of claim 14, wherein said ratio is in the range from 1.2:1 to 1.5:1.
